(19) United States
(12) Patent Application Publication
(10) Pub. No.: US 2004/0103673 A1
(43) Pub. Date: Jun. 3, 2004

(54) Instant A/C checker

(75) Inventor: Kwangtaek Hong, Ann Arbor, MI (US)

Correspondence Address: Ralph E. Smith, daimler Chrysler Intellectual Capital Corp., 800 Chrysler Drive East, Auburn Hill, MI, 48326-2757, US

(73) Assignee: Daimler Chrysler Corporation

(21) Appl. No.: 10/307,393

(22) Filed: Dec. 2, 2002

(51) Int. Cl. G01K 13/00; F25B 45/00

(52) U.S. Cl. 62/129; 62/292

(57) ABSTRACT

A method for detecting a low-charge state in an air conditioning system. In one aspect, the temperature/pressure of the discharge of the condenser is measured to determine whether a low-charge state exists in the refrigeration system by calculating the degrees of subcooling of the refrigerant and comparing that to a predetermined minimum value. In another aspect, the temperature/pressure of the discharge of the compressor is measured to determine whether a low-charge state is indicated by calculating the degrees of superheat of the refrigerant and comparing that value with a predetermined maximum value. An air conditioning checker is also disclosed.

### BACKGROUND

The invention relates generally to air conditioning systems and more particularly to an apparatus and method for detecting the amount of charge of an air conditioning system.

Air conditioning systems typically include a compressor, a condenser, a throttling device and an evaporator. Operation of the system involves flowing a refrigerant through the compressor, which adds heat and increases the pressure of the refrigerant. The high-temperature, high-pressure gaseous refrigerant exiting the compressor is then delivered to the condenser where excess heat is removed, causing the refrigerant to exit the condenser as a relatively low-temperature, high-pressure liquid refrigerant. The liquid refrigerant is then conveyed to the expansion valve which meters the amount of refrigerant that is discharged to the evaporator, thereby causing the low-temperature, high-pressure liquid refrigerant to convert to a low-temperature, low-pressure gaseous state. A blower forces air over a heat exchanger surface on the evaporator causing the gaseous refrigerant to absorb heat and the blown air to cool. The gaseous refrigerant is then returned to the compressor and the cycle is repeated continuously.

To maintain the performance of the air conditioning system, it is necessary that the system be properly charged (i.e., the system must have a quantity of refrigerant that exceeds a predetermined minimum amount). If the air conditioning system looses a sufficient amount of refrigerant, the air conditioning system will not effectively cool the air to the maximum extent possible, and if the charge is low enough may not cool the air at all. Furthermore, operation of the air conditioning system in a low-charge state may damage the compressor, which is typically the most expensive component of the air conditioning system.

Conventional air conditioning systems do not include a means for detecting a low-charge state. Consequently, it is necessary to rely on the perception and judgment of the users of these systems to detect symptoms that are characteristic of a low-charge state. The symptom most readily detected with such systems is an output temperature of air exiting the evaporator that is “warmer than normal”. Unfortunately, as the loss of refrigerant from an air conditioning system is usually gradual, the user is not likely to notice the change in the output temperature until a substantial amount of refrigerant has been lost from the system.

Complicating matters is that technicians responsible for trouble-shooting and maintaining these air conditioning systems have no direct means for detecting a low-charge state. As such, the technician is typically forced to employ a decision-making process having several steps of relatively low reliability to develop a plan for dealing with the observations of the air conditioning system user. The process usually includes the verification that the output temperature is relatively high and then re-charging the air conditioning system. Recharging the air conditioning system is a time consuming process, requiring that the refrigerant in the air conditioning system first be evacuated and then a proper quantity of fresh refrigerant be delivered to the air conditioning system. This process typically requires several hours to complete, tying up not only the technician, but also other resources such as the tooling, equipment and possibly even a service bay.

Considering modern standards of accuracy and repeatability, this trouble-shooting process renders it highly likely that some air conditioning systems are being recharged unnecessarily. Furthermore, it is also likely that other air conditioning systems may not be being serviced when such is necessary. To avoid these situations, some air conditioning systems have proposed the use of a dedicated sensor in an attempt to more reliably detect a low-charge state. One such system relies on a low-pressure sensor placed between the evaporator and the compressor. Here, the liquid refrigerant delivered from the evaporator to the compressor will have a relatively lower pressure if the compressor is operated in a low-charge state. This approach adds a considerable amount of cost to the air conditioning system, and requires a substantial reduction in the pressure of the refrigerant delivered to the compressor before a low-charge state is detected. Accordingly, it is possible in a system of this type that the low-charge state will go undetected for a considerable period of time, permitting the compressor to be operated repeatedly and damaged.

Another system relies on a sub-cool temperature sensor placed between the condenser and the expansion valve that monitors the temperature of the gaseous refrigerant delivered to the expansion valve. While this arrangement has been shown to be effective at detecting a low-charge state, it is extremely costly, being approximately three times more expensive than the low-pressure sensor discussed above.

In yet another system, a method for detecting a low-charge state in an air conditioning system involves detecting the temperature of air exiting an evaporator, the temperature of ambient air, and an air conditioning control head operational signal (blower speed, mode, etc.) to detect a low-charge condition of the air conditioning system. While this is an effective arrangement, this system suffers from the fact that it would not work with the baseline air conditioning control head that does not employ the required electronics and is more complicated than the present invention. Accordingly, there remains a need in the art for an air conditioning system that is able to detect a low-charge condition in a reliable manner and at a relatively low cost.

### SUMMARY OF THE INVENTION

It is one object of the present invention to provide a method for detecting a low-charge state in an air conditioning system that provides reliable results in a plant and dealer environment.

It is another object of the present invention to provide a method for detecting a low-charge state in an air conditioning system that is fast, easy and has a simply and economic operation.

It is a further object of the present invention to provide a method for detecting a low-charge state in an air conditioning system that employs monitoring the temperature and pressure of the coolant after exiting the condenser to determine the existence of a low-charge state for the TXV (thermal expansion valve) system.

It is yet another object of the present invention to provide a method for detecting a low-charge state in an air conditioning system that employs monitoring the temperature and pressure of the coolant after exiting the compressor to determine the existence of a low-charge state for the CCOT (Compressor Cycled Orifice Tube) system.

In one preferred form, the present invention provides a method and apparatus for detecting a low-charge state in an air conditioning system. For the TXV system, the method includes detecting a temperature/pressure of the refrigerant downstream of the condenser and responsively producing a condenser temperature/pressure signal; detecting an ambient air temperature and responsively producing an ambient air temperature signal; and determining the degrees of subcool of the refrigerant and responsively detecting a low-charge condition of the compressor, where the degrees of subcool is less than a predetermined minimum amount. For the CCOT system, the method includes detecting a temperature/pressure of the refrigerant downstream of the compressor and responsively producing a compressor temperature/pressure signal; detecting an ambient air temperature and responsively producing an ambient air temperature signal; and determining the degrees of superheat and responsively detecting a low-charge condition of the compressor, where the degrees of superheat is greater than a predetermined maximum amount. In one embodiment utilizing a TXV system, the apparatus includes a condenser, a condenser temperature/pressure sensor, an ambient air temperature sensor, and an air conditioning checker for determining the amount of subcool of the refrigerant. In another embodiment that employs a CCOT system, the apparatus includes a compressor, a compressor temperature/pressure sensor, an ambient air temperature sensor, and an air conditioning checker for determining the amount of superheat of the refrigerant.

Other objects, advantages and novel features of the present invention will become apparent from the following detailed description of the invention when considered in conjunction with the accompanying drawings.

### BRIEF DESCRIPTION OF THE DRAWINGS

FIG. 1 provides a schematic view of an air conditioning system.

FIG. 2 illustrates an air conditioning checker according to the principles of the invention.

### DETAILED DESCRIPTION OF THE DRAWINGS

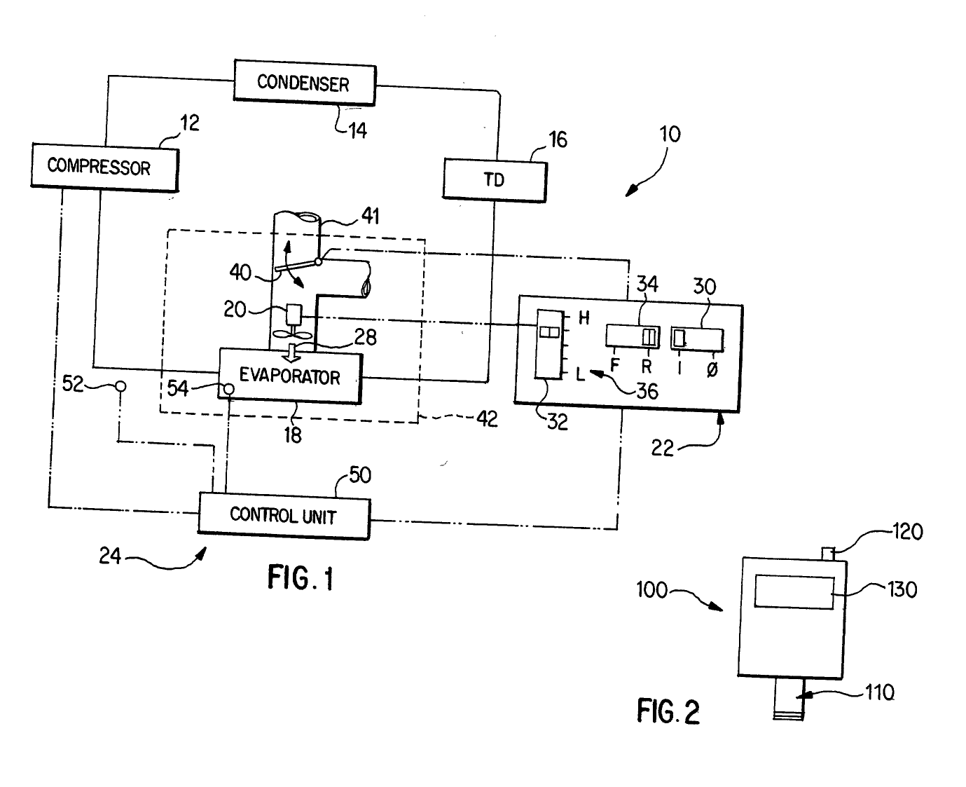

With reference to FIG. 1 of the drawings, an air conditioning system constructed in accordance with the teachings of the present invention is generally indicated by reference numeral 10. Air conditioning system 10 is shown to include a compressor 12, a condenser 14, a throttling device 16, an evaporator 18, a blower 20, a control panel 22 and a controller 24. Compressor 12, condenser 14, throttling device 16, evaporator 18, blower 20 and control panel 22 are conventional in their construction and operation and as such, need not be discussed in detail. Briefly, compressor 12 is operable for increasing the pressure of a gaseous refrigerant. Heat is a byproduct of the process and as such, the refrigerant exiting compressor 12 is also at an elevated temperature. High-temperature, high-pressure gaseous refrigerant exiting compressor 12 is delivered to condenser 14 where heat is discharged from the refrigerant to a heat exchanger surface of the condenser 14. Air is forced over the heat exchanger surface of the condenser 14, either by a mechanical device, such as a fan, or the movement of the condenser 14 through its environment, such as in a vehicular application, causing condenser 14 to release heat to the environment. This permits condenser 14 to continuously cool the refrigerant, causing the refrigerant to condense such that relatively low-temperature, high-pressure liquid refrigerant is discharged to throttling device 16.

Throttling device 16, which may be a thermal expansion valve or an orifice tube, is operable for metering the amount of refrigerant that is discharged to evaporator 18. The metering operation of throttling device 16 creates a pressure differential which permits the refrigerant delivered to evaporator 18 to change to a low-temperature, low-pressure gaseous state. Evaporator 18 facilitates the transfer of heat between the gaseous refrigerant and the output air 28, which is forced over the heat transfer surfaces of the evaporator 18 by blower 20.

Control panel 22 and controller 24 are employed to control the operation of air conditioning system 10. Control panel 22 includes a power switch 30, a blower speed switch 32 and a mode switch 34. Power switch 30 is operable in a first state for activating air conditioning system 10 and a second state for deactivating air conditioning system 10. Blower speed switch 32 includes a plurality of speed positions 36 which are operable for selectively controlling the speed with which blower 20 operates. In the particular example illustrated, blower speed switch 32 has four positions, each of which provides a different voltage to blower 20. Accordingly, a switch position that provides the highest voltage to blower 20 would cause blower 20 to operate at its highest speed. Similarly, a switch position that provides the lowest voltage to blower 20 would cause blower 20 to operate at its lowest speed.

Mode switch 34 is operable for selectively controlling the source of the air used for output air 28. Placement of mode switch 34 in a first state causes a valve 40 to cooperate with a duct 41 to form a flow path which permits air to be drawn in from the exterior of the structure 42 which air conditioning system 10 is cooling. Structure 42 may be a stationary structure, such as a room or a house, or may be a mobile structure, such as an automotive vehicle. Placement of mode switch 34 in a second state causes valve 40 to cooperate with duct 41 to form a flow path which permits air within the structure 42 to be recirculated to evaporator 18. Control panel 22 generates signals corresponding to the operational characteristics of air conditioning system 10 and responsively produces an operational signal in response thereto.

FIG. 2 illustrates one embodiment constructed according to the principles of the invention. Air conditioning checker 100 is depicted having a pressure/temperature sensor 110 for fluid communication with the refrigerant of the air conditioning system, an ambient temperature sensor 120, and a display 130 for indicating temperatures and/or pressures as selected by the user. Other suitable sensors and displays may be added to checker 100 as is known in the art for the convenience and assistance of the service person checking the charge on the air conditioning system 10.

All vehicles having an air conditioning system have two service ports, one in the low-pressure side and one in the high-pressure side of their system. In one aspect of the invention for a TXV system, air conditioning checker 100 is connected downstream of the condenser 14 in the low-pressure side of the system. After connection is made, the amount of subcool is calculated. If the subcool is less than about 5° F., then the system has a low charge of refrigerant. Alternatively, if the subcool is between about 5° F. and about 35° F., the system has a normal charge. Finally, if the subcool is greater than about 35° F., the system is overcharged.

In another aspect of the invention and in connection with a CCOT system, air conditioning checker 100 is connected downstream of the compressor 12 in the high-pressure side of the system. After connection is made, the amount of superheat is calculated. If the superheat is greater than about 70° F. then the system has a low charge of refrigerant. Alternatively, if the superheat is between about 30° F. and about 50° F., the system has a normal charge. Finally, if the superheat is less than about 10° F., the system is overcharged.

While the invention has been described in the specification and illustrated in the drawings with reference to a preferred embodiment, it will be understood by those skilled in the art that various changes may be made and equivalents may be substituted for elements thereof without departing from the scope of the invention as defined in the claims. In addition, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the description of the appended claims.

What is claimed is:

1. A method for detecting a low-charge refrigerant state of a compressor in a motor vehicle air conditioning system, the air conditioning system further including a condenser, the method comprising:
detecting a temperature/pressure of the refrigerant downstream of the condenser and responsively producing a condenser temperature/pressure signal;
detecting an ambient air temperature and responsively producing an ambient air temperature signal;
determining the degrees of subcool of the refrigerant and responsively detecting a low-charge condition of the compressor.

2. The method of claim 1, wherein the low-charge condition is detected when the degrees of subcool is less than a predetermined minimum amount.

3. The method of claim 2, wherein the predetermined amount is less than 5° F.

4. An air conditioning system comprising:
a condenser for cooling a pressurized refrigerant;
a condenser temperature/pressure sensor operable for sensing a temperature of the refrigerant downstream of the condenser and generating a condenser temperature/pressure signal in response thereto;
an ambient air temperature sensor operable for sensing an ambient air temperature and generating an ambient air temperature signal in response thereto; and
an air conditioning checker for receiving the condenser temperature/pressure and ambient air temperature signals and determining the amount of subcool of the refrigerant.

5. The system of claim 4, wherein the air conditioning checker detects a low-charge condition when the amount of subcool is less than a predetermined minimum amount.

6. The system of claim 5, wherein the predetermined amount is less than 5° F.

7. A method for detecting a low-charge refrigerant state of a compressor in a motor vehicle air conditioning system comprising:
detecting a temperature/pressure of the refrigerant downstream of the compressor and responsively producing a compressor temperature/pressure signal;
detecting an ambient air temperature and responsively producing an ambient air temperature signal;
determining the degrees of superheat of the refrigerant and responsively detecting a low-charge condition of the compressor.

8. The method of claim 7, wherein the low-charge condition is detected when the degrees of superheat is greater than a predetermined maximum amount.

9. The method of claim 8, wherein the predetermined maximum amount is 70° F.

10. An air conditioning system comprising:
a compressor for cooling a pressurized refrigerant;
a compressor temperature/pressure sensor operable for sensing a temperature/pressure of the refrigerant downstream of the compressor and generating a compressor temperature/pressure signal in response thereto;
an ambient air temperature sensor operable for sensing an ambient air temperature and generating an ambient air temperature signal in response thereto; and
an air conditioning checker for receiving the compressor temperature/pressure and ambient air temperature signals and determining the amount of superheat of the refrigerant.

11. The system of claim 10, wherein the air conditioning checker detects a low-charge condition when the amount of superheat is greater than a predetermined maximum amount.

12. The system of claim 11, wherein the predetermined maximum amount is 70° F.
